(19) United States
(12) Patent Application Publication
(10) Pub. No.: US 2025/0184766 A1
(43) Pub. Date: Jun. 5, 2025

(54) COMMUNICATION METHOD AND COMMUNICATION APPARATUS FOR SENSING BY PROXY

(71) Applicant: Beijing Xiaomi Mobile Software Co., Ltd., Beijing (CN)

(72) Inventor: Xiandong DONG, Beijing (CN)

(21) Appl. No.: 18/842,015

(22) PCT Filed: Mar. 4, 2022
(86) PCT No.: PCT/CN2022/079327

§ 371 Date: Aug. 27, 2024

(51) Int. Cl. H04W 24/02; H04W 84/12

(52) U.S. Cl. CPC H04W 24/02; H04W 84/12

(57) ABSTRACT

A communication method for sensing by proxy (SBP) includes: determining an SBP termination frame, where the SBP termination frame includes an identification bit for identifying a completion status of sensing measurement; and sending the SBP termination frame.

### CROSS-REFERENCE TO RELATED APPLICATIONS

The present application is a U.S. National Stage of International Application No. PCT/CN2022/079327, entitled “COMMUNICATION METHOD AND COMMUNICATION DEVICE FOR SENSING BY PROXY”, filed on Mar. 4, 2022, the contents of all of which are incorporated herein by reference in their entireties for all purposes.

### BACKGROUND

The wireless local area network (WLAN) has characteristics of flexibility, mobility, low cost and the like. With the development of the communication technology and increasing of user demands, the application research of the WLAN is gradually deepened. For example, at present, WLAN sensing is being researched, with application scenes being: location discovery in dense environments (a home environment and an enterprise environment), a proximity detection and a presence detection, etc.

### SUMMARY

The disclosure relates to the field of wireless communication, and more specifically, to a communication method and communication apparatus for sensing by proxy (SBP).

According to various examples of the disclosure, the following technical solution is provided.

According to an example of the disclosure, a communication method for sensing by proxy (SBP) is provided. The communication method may include: determining an SBP termination frame, where the SBP termination frame may include an identification bit for identifying a completion status of sensing measurement; and sending the SBP termination frame.

According to an example of the disclosure, a communication method for sensing by proxy (SBP) is provided. The communication method may include: receiving an SBP termination frame, where the SBP termination frame may include an identification bit for identifying a completion status of sensing measurement; and performing corresponding operations based on the SBP termination frame.

According to an example of the disclosure, a communication apparatus for sensing by proxy (SBP) is provided. The communication apparatus may include: a processing module, configured to determine an SBP termination frame, where the SBP termination frame may include an identification bit for identifying a completion status of sensing measurement; and a transceiving module, configured to send the SBP termination frame.

According to an example of the disclosure, a communication apparatus for sensing by proxy (SBP) is provided. The communication apparatus may include: a transceiving module, configured to receive an SBP termination frame, where the SBP termination frame may include an identification bit for identifying a completion status of sensing measurement; and a processing module, configured to control performing corresponding operations based on the SBP termination frame.

According to an example of the disclosure, an electronic apparatus is provided. The electronic apparatus includes a memory, a processor and a computer program stored on the memory and capable of running on the processor. The processor, when executing the computer program, implements the communication method above.

According to an example of the disclosure, a non-transitory computer readable storage medium is provided. A computer program is stored on the non-transitory computer readable storage medium. The computer program, when executed by a processor, implements the communication method above.

### BRIEF DESCRIPTION OF DRAWINGS

The examples of the disclosure are described in detail by referring to accompanying drawings, and above and other features of examples of the disclosure will be more apparent.

FIG. 1 shows an example mode of WLAN sensing.

FIG. 2 shows a flow chart of a communication method according to an example.

FIG. 3 shows a flow chart of another communication method according to an example.

FIG. 4 shows a block diagram of a communication apparatus according to an example.

### DETAILED DESCRIPTION

The description of the following referring accompanying drawings is provided to help completely understand various examples of the disclosure limited by appended claims and their equivalents. The various examples of the disclosure include various specific details, but these details are considered as example. In addition, for clear and concise description, descriptions of the well-known technologies, functions and structures may be omitted.

Terms and words used in the disclosure are not limited to written meaning, but are used by the inventor, so as to clearly and consistently understand the disclosure. For those skilled in the art, the description of the various examples of the disclosure is intended to explain, but not to limit.

It is to be understood that unless the context clearly states otherwise, singular forms “one”, “a/an”, “said” and “the” used here may also include plural forms. It may be further understood that an expression “include” used in the disclosure refers to existence of described features, integers, steps, operations, elements and/or components, but does not exclude existence or addition of one or more other features, integers, steps, operations, elements, components and/or a combination of them.

It will be understood that although terms “first”, “second”, etc. in the context may be used to describe various elements, these elements are not limited by these terms. These terms are used to distinguish one element from another element. A first element discussed below may be called a second element without departing from teaching of an example.

It is to be understood that in a case that an element is called being “connected” or “coupled” to another element, the element may be directly connected or coupled to other elements, or a middle element may also exist. In addition, “connect” or “couple” used here may include wireless connection or wireless coupling. Terms “and/or” used here or an expression “at least a/at least one in . . . ” include any or all combinations of one or more related listed items.

Unless otherwise defined, all terms (including technical terms and scientific terms) used here have meanings the same as those generally understood by those ordinarily skilled in the art to which the disclosure pertains.

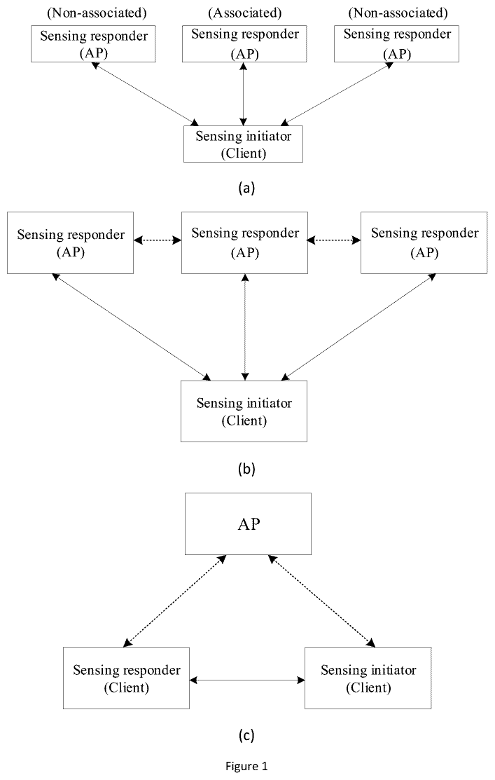

FIG. 1 shows an example mode of WLAN sensing.

Flows of the WLAN sensing may be: an initiator initiates the WLAN sensing (for example, initiating a WLAN sensing session), a plurality of responders may exist for response, and specific possible modes may be shown as (a), (b) and (c) in FIG. 1.

Referring to (a) in FIG. 1, in a case that the initiator (for example, a client) of the WLAN sensing initiates the WLAN sensing, a plurality of associated or non-associated WLAN sensing responders (for example, three access points (APs)) may respond. “Association” here may refer to that an association connection for communication is established between the initiator and the responders, and “non-association” may refer to that an association connection for communication is not established between the initiator and the responders.

For example, the client may include but is not limited to: a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

The AP may be a wireless switch for a wireless network, and may also be an access device of the wireless network. The AP may include a software application and/or circuit, so as to enable other types of nodes in the wireless network to communicate with an exterior and an interior of the wireless network through the AP. For example, the AP may be a terminal device or a network device equipped with a wireless fidelity (Wi-Fi) chip.

(b) in FIG. 1 is similar to (a) in FIG. 1, but in (b) in FIG. 1, the responders (AP) may communicate with each other.

Referring to (c) in FIG. 1, the initiator of the WLAN sensing and the responders of the WLAN sensing both may be the client, and the two may be connected to the same AP for communication.

Although (a), (b) and (c) in FIG. 1 show that the client serves as the initiator, the AP serves as the responder, the disclosure is not limited to this, for example, the AP may serve as the initiator, and the client may serve as the responder. In addition, the quantity of the initiator and the responder is not limited to (a), (b) and (c) shown in FIG. 1.

As an illustrative example, a conventional WLAN sensing process may include: a WLAN sensing session establishment stage, a WLAN sensing measurement establishment stage and a WLAN sensing measurement termination stage. In the WLAN sensing session establishment stage, the initiator may initiate one or more WLAN sensing sessions. In the WLAN sensing measurement establishment stage, the initiator may perform one or more WLAN sensing measurement establishments. For example, for each WLAN sensing session, the initiator may establish one or more WLAN sensing measurements, where the established one or more WLAN sensing measurements may perform identifying or distinguishing through a sensing measurement setup ID. Each established sensing measurement may include one or more sensing measurement events, and sensing measurement operations are performed in each sensing measurement event. In addition, a report operation for performing a sensing measurement result may further be selectively performed. In the WLAN sensing measurement termination stage, the sensing measurement is stopped and the sensing session is terminated. However, this is example, and stages of the WLAN sensing measurement may be differently divided.

In order to increase the efficiency of the WLAN sensing measurement, a mode of sensing by proxy (SBP) may be adopted. That is, an SBP request (for example, an SBP requesting frame) may be sent to an AP (referred to as “SBP AP”, “proxy AP” or “AP” in the below) supporting the SBP by a station (referred to as “SBP STA”, “SBP requesting STA”, “SBP requesting station”, or “STA” in the below), and the AP, together with one or more STAs (may include STA sending the SBP request) serving as responders, completes the WLAN sensing measurement. Examples of the station (or SBP STA, SBP requesting STA, SBP requesting station, or STA) may be similar to examples of the client above, the AP (or SBP AP, proxy AP, or AP) supporting the SBP may be similar to examples of the AP above, and for conciseness, repeated descriptions are omitted here.

In the entire flow of the SBP, an SBP termination may further exist, which may be initiated by the SBP AP or the SBP requesting STA. However, at present, a mechanism of the SBP termination is not perfect. For example, SBP AP initiation may have two cases: 1, measurement is completed, and the SBP termination is initiated by the SBP AP; and 2, after the SBP AP sends an SBP response frame, a sensing measurement is established according to demands of the SBP requesting STA in the SBP requesting frame and an appropriate responder STA, but the STA (responder) meeting demands of sensing measurement parameters in the SBP requesting frame may be not found, and a termination frame is replied to the SBP requesting STA. However, in a case that the termination frame is merely replied to the SBP requesting STA, a termination reason is not included, the SBP requesting STA may send the SBP requesting frame to the SBP AP again, for example, even though the termination frame is sent in a case of completing measurement, the SBP requesting STA may send the SBP requesting frame again, resulting in waste of resources, and reinforcement is needed.

In view of this, a communication method and a communication apparatus according to examples of the disclosure are provided.

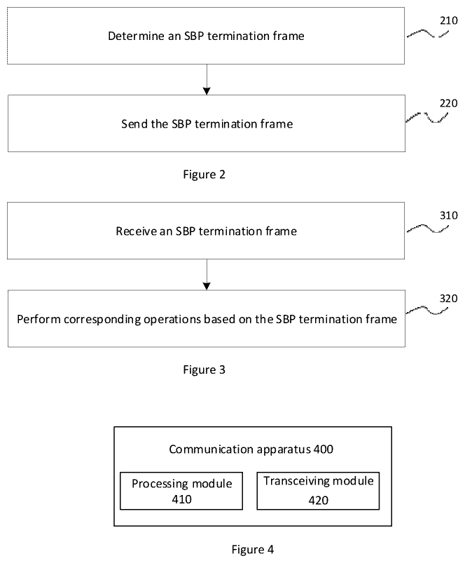

FIG. 2 shows a flow chart of a communication method according to an example. The communication method shown in FIG. 2 may be an operation executed by a sending device, for example, the communication method shown in FIG. 2 may be executed by an SBP requesting station (namely, SBP requesting STA) or an SBP access point (namely, SBP AP).

Referring to FIG. 2, in step 210, an SBP termination frame is determined, where the SBP termination frame may include an identification bit for identifying a completion status of sensing measurement. In step 220, the SBP termination frame may be sent. According to the example of the disclosure, sending the SBP termination frame may also be called “initiation of SBP”.

According to the example of the disclosure, the SBP termination frame may have various frame formats. For example, the SBP termination frame may be another type of the SBP requesting frame, and a bit in the SBP requesting frame may be set to a particular value, and identified as the SBP termination frame (it may be initiated by the SBP requesting STA or the SBP AP). In other words, the SBP termination frame and the SBP requesting frame may have the similar format, but the type of the SBP termination frame needs to be set. For example, the SBP termination frame may further include a type identification bit for identifying a frame type as the SBP termination frame. That is, the above bit set to the particular value may refer to the type identification bit in the SBP termination frame. However, it is example, the disclosure is not limited to this, and the SBP termination frame may be implemented through other different frame formats. In addition, the SBP termination frame with a specific format may be defined, that is, the type identification bit in the example may not be carried.

According to the example of the disclosure, the SBP termination frame may be determined through various methods. For example, in a case that the communication method in FIG. 2 is executed by the SBP requesting station, the SBP requesting station may determine the SBP termination frame according to whether receiving a sensing measurement result (specifically, the above identification bit in the SBP termination frame is determined). For example, in a case that the communication method in FIG. 2 is executed by the SBP access point (AP), the SBP access point (AP) may determine the SBP termination frame according to whether establishing the sensing measurement meeting the demands in the SBP requesting frame and whether completing the sensing measurement (specifically, the above identification bit in the SBP termination frame is determined).

When determining the SBP termination frame, the identification bit in the SBP termination frame may be set to different values to identify a completion status of sensing measurement. For example, the completion status of the sensing measurement may include: sensing measurement has been completed, or the sensing measurement has not been completed (for example, the sensing measurement cannot be completed due to the fact that no station meeting the demands of the SBP requesting station is found to be participated in the sensing measurement).

According to the example of the disclosure, the identification bit may be set to a first value to identify that the sensing measurement has been completed, and in this case, a device sending the SBP termination frame may be the SBP requesting station or the SBP access point (AP).

According to the example of the disclosure, the identification bit may be set to a second value to identify that no station meeting demands of the SBP requesting station is found to be participated in the sensing measurement and a termination flow is initiated, and in this case, the device sending the SBP termination frame may be merely the SBP access point (AP).

As a non-restrictive example, the identification bit for identifying the completion status of the sensing measurement may be included in the SBP termination frame in a form of “a reason code”. For example, the reason code may be set to identify that the sensing measurement has been completed (corresponding to the above “first value”), or set to identify that on station meeting the demands of the SBP requesting station is found to be participated in the sensing measurement and the termination flow is initiated (corresponding to the above “second value”).

According to the example of the disclosure, the SBP termination frame may further include a sensing measurement setup ID corresponding to the sensing measurement. According to the setting of the identification bit (for example, the reason code), the sensing measurement setup ID may correspond to different meanings.

For example, in a case that the identification bit is set to a first value, the sensing measurement setup ID may correspond to the completed sensing measurement. That is to say, in a case that the identification bit is set to identify the sensing measurement has been completed, in response to determining that the SBP termination frame further carries the sensing measurement setup ID, the sensing measurement setup ID may refer to that which sensing measurement is completed. This way may be called explicitly identifying that the sensing measurement has been completed. However, the disclosure is not limited to this, and may also implicitly identify that the sensing measurement has been completed. That is, the SBP termination frame does not carry the sensing measurement setup ID, for example, the sensing measurement and its sensing measurement setup ID corresponding to the SBP termination frame may be known according to an interactive process of signaling.

For example, in a case that the identification bit is set to a second value, the sensing measurement setup ID may be withdrawn. According to the example of the disclosure, the sensing measurement setup ID may be distributed to STA by SBP AP in the SBP response frame, for example, the sensing measurement setup ID is pre-distributed after the SBP AP receives the SBP requesting frame (a pre-distribution mode), or is distributed in a process that the SBP AP establishes the sensing measurement based on the demands of the sensing measurement in the SBP requesting frame and an appropriate responder (a post-distribution mode). In a case that the identification bit (for example, the reason code) is set to identify that no station meeting the demands of the SBP requesting station is found to be participated in the sensing measurement and the termination flow is initiated, in response to determining that the SBP termination frame further carries the sensing measurement setup ID, the sensing measurement setup ID may refer to a withdrawn pre-distributed or post-distributed sensing measurement setup ID. However, the disclosure is not limited to this, the SBP termination frame may also carry the sensing measurement setup ID not in this explicit mode, for example, the sensing measurement corresponding to the SBP termination frame may be known according to the interactive process of signaling, and in response to determining that the identification bit (for example, the reason code) is parsed to be set to identify that no station meeting the demands of the SBP requesting station is found to be participated in the sensing measurement and the termination flow is initiated, information that the corresponding sensing measurement setup ID is withdrawn is simultaneously or automatically known. This withdrawal mechanism of the sensing measurement setup ID can avoid waste of resources.

According to the example of the disclosure, in the case that the identification bit (for example, the reason code) is set to the second value, the SBP termination frame may further include a time information bit and a sensing measurement setup ID, the time information bit may be configured to identify time at which the SBP requesting station sends an SBP requesting frame for the sensing measurement again, and the sensing measurement setup ID may be an existing sensing measurement setup ID of the sensing measurement. In this case, the SBP termination frame is initiated by the SBP access point (AP), since the identification bit (for example, the reason code) identifies that a reason for initiating the SBP termination frame is that the sensing measurement is not completed, the time at which the SBP requesting station sends the SBP requesting frame for the sensing measurement again and the existing sensing measurement setup ID of the sensing measurement may be explicitly stipulated in the SBP termination frame. For example, the SBP requesting STA may send the SBP requesting frame again within specific time (namely, time identified by the time information bit) of the SBP AP, and the existing corresponding sensing measurement setup ID may be carried. The existing sensing measurement setup ID of the sensing measurement may refer to a sensing measurement setup ID distributed at the last time the SBP requesting frame was sent, the sensing measurement setup ID is carried in the SBP termination frame, the situation that the sensing measurement setup ID is repeatedly distributed aiming at the SBP requesting frame sent again may be avoided, the signaling is saved, and waste of resources is avoided.

According to the example of the disclosure, the SBP termination frame may be another type of the SBP requesting frame, and a bit (for example, the type identification bit) in the SBP requesting frame may be set to a particular value, and identified as the SBP termination frame (it may be initiated by the SBP requesting STA or the SBP AP). For example, the SBP termination frame may include the reason code. For example, the SBP termination frame may further include a corresponding measurement setup ID (it may be distributed to STA by SBP AP in the SBP response frame), in response to determining that the SBP termination frame is sent by the SBP requesting STA or the SBP AP, the reason code may be set to identify that the sensing measurement has been completed, and the SBP sensing measurement corresponding to the measurement setup ID is terminated; in response to determining that the SBP termination frame is merely initiated by the SBP AP, the reason code may be set to identify that no STA meeting the demands of the SBP requesting STA is found to be participated in the sensing measurement and the termination flow is initiated, and the corresponding measurement setup ID is withdrawn; or further, the SBP requesting STA may send the SBP requesting frame again within the specific time of the SBP AP, and the existing corresponding sensing measurement setup ID may be carried.

According to various examples of the disclosure, contents carried in the SBP termination frame may have different transformations.

An example of the disclosure further provides a communication method for sensing by proxy (SBP). The communication method may be performed by an SBP requesting station, and may include: an SBP termination frame is determined, where the SBP termination frame may include an identification bit (for example, the reason code) for identifying that sensing measurement has been completed; and the SBP termination frame is sent.

An example of the disclosure further provides a communication method for sensing by proxy (SBP). The communication method may be performed by an SBP requesting station, and may include: an SBP termination frame is determined, where the SBP termination frame may include an identification bit for identifying termination of sensing measurement; and the SBP termination frame is sent. In other words, the SBP requesting station may initiatively terminate certain sensing measurement.

An example of the disclosure further provides a communication method for sensing by proxy (SBP). The communication method may be performed by an SBP requesting station, and may include: an SBP termination frame is determined, where the SBP termination frame may include a type identification bit for identifying a frame type as the SBP termination frame; and the SBP termination frame is sent. In other words, in response to determining that the SBP termination frame is initiated by the SBP requesting station, an identification bit such as the reason code may not be carried, and the SBP termination frame itself may identify that the sensing measurement has been completed.

An example of the disclosure further provides a communication method for sensing by proxy (SBP). The communication method may be performed by an SBP requesting station, and may include: an SBP termination frame is determined, where the SBP termination frame may include a sensing measurement setup ID corresponding to completed sensing measurement; and the SBP termination frame is sent.

An example of the disclosure further provides a communication method for sensing by proxy (SBP). The communication method may be performed by an SBP requesting station, and may include: an SBP termination frame is determined, where the SBP termination frame may include an identification bit (for example, the reason code) for identifying that sensing measurement has been completed, and/or a sensing measurement setup ID corresponding to the sensing measurement; and the SBP termination frame is sent.

An example of the disclosure further provides a communication method for sensing by proxy (SBP). The communication method may be performed by an SBP requesting station, and may include: an SBP termination frame is determined, where the SBP termination frame may include a type identification bit for identifying a frame type as the SBP termination frame, an identification bit (for example, the reason code) for identifying that sensing measurement has been completed, and/or a sensing measurement setup ID corresponding to the sensing measurement; and the SBP termination frame is sent.

An example of the disclosure further provides a communication method for sensing by proxy (SBP). The communication method may be performed by an SBP access point (AP), and may include: an SBP termination frame is determined, where the SBP termination frame may include an identification bit (for example, the reason code) for identifying that sensing measurement has been completed; and the SBP termination frame is sent.

An example of the disclosure further provides a communication method for sensing by proxy (SBP). The communication method may be performed by an SBP access point (AP), and may include: an SBP termination frame is determined, where the SBP termination frame may include an identification bit (for example, the reason code) for identifying that sensing measurement has been completed, and a type identification bit for identifying a frame type as the SBP termination frame; and the SBP termination frame is sent.

An example of the disclosure further provides a communication method for sensing by proxy (SBP). The communication method may be performed by an SBP access point (AP), and may include: an SBP termination frame is determined, where the SBP termination frame may include a sensing measurement setup ID; and the SBP termination frame is sent. For example, an identification bit (for example, the reason code) for identifying that sensing measurement has been completed may be omitted in the SBP termination frame, in a case that the SBP termination frame sent by the SBP access point (AP) is received, the SBP station can check whether a sensing measurement result (for example, channel state information (CSI) from each responder STA) corresponding to the sensing measurement setup ID in the SBP termination frame is received, in response to determining that the sensing measurement result is received, it is determined that the SBP termination frame identifies that the sensing measurement has been completed; and in response to determining that the sensing measurement result is not received, it is determined that the SBP termination frame identifies incompletion and termination of the corresponding sensing measurement.

An example of the disclosure further provides a communication method for sensing by proxy (SBP). The communication method may be performed by an SBP access point (AP), and may include: an SBP termination frame is determined, where the SBP termination frame may include a type identification bit for identifying a frame type as the SBP termination frame, an identification bit (for example, the reason code) for identifying that sensing measurement, and/or a sensing measurement setup ID corresponding to the sensing measurement; and the SBP termination frame is sent.

An example of the disclosure further provides a communication method for sensing by proxy (SBP). The communication method may be performed by an SBP access point (AP), and may include: an SBP termination frame is determined, where the SBP termination frame may include an identification bit (for example, the reason code) for identifying that no station meeting demands of the SBP requesting station is found to be participated in sensing measurement and a termination flow is initiated; and the SBP termination frame is sent.

An example of the disclosure further provides a communication method for sensing by proxy (SBP). The communication method may be performed by an SBP access point (AP), and may include: an SBP termination frame is determined, where the SBP termination frame may include an identification bit (for example, the reason code) for identifying that no station meeting demands of the SBP requesting station is found to be participated in sensing measurement and a termination flow is initiated, and a sensing measurement setup ID to be withdrawn; and the SBP termination frame is sent.

An example of the disclosure further provides a communication method for sensing by proxy (SBP). The communication method may be performed by an SBP access point (AP), and may include: an SBP termination frame is determined, where the SBP termination frame may include an identification bit (for example, the reason code) for identifying that no station meeting demands of the SBP requesting station is found to be participated in sensing measurement and a termination flow is initiated, and a type identification bit for identifying a frame type as the SBP termination frame; and the SBP termination frame is sent.

An example of the disclosure further provides a communication method for sensing by proxy (SBP). The communication method may be performed by an SBP access point (AP), and may include: an SBP termination frame is determined, where the SBP termination frame may include an identification bit (for example, the reason code) for identifying that no station meeting demands of the SBP requesting station is found to be participated in sensing measurement and a termination flow is initiated, a time information bit and a sensing measurement setup ID; and the SBP termination frame is sent.

An example of the disclosure further provides a communication method for sensing by proxy (SBP). The communication method may be performed by an SBP access point (AP), and may include: an SBP termination frame is determined, where the SBP termination frame may include a time information bit and a sensing measurement setup ID; and the SBP termination frame is sent. In other words, in a case that the SBP termination frame includes the time information bit, an identification bit such as the reason code may be omitted in the SBP termination frame, and the SBP termination frame may implicitly identify that no station meeting demands of the SBP requesting station is found to be participated in sensing measurement and a termination flow is initiated.

FIG. 3 illustrates a flow chart of another communication method according to an example. The communication method shown in FIG. 3 may be an operation performed by a receiving device. For example, the communication method shown in FIG. 3 may be performed by an SBP access point (namely, SBP AP) or an SBP requesting station (namely, SBP requesting STA).

Referring to FIG. 3, in step 310, the SBP termination frame may be received, where the SBP termination frame may include an identification bit (for example, the reason code) for identifying a completion status of sensing measurement.

According to the example of the disclosure, the identification bit may be set to a first value to identify that the sensing measurement has been completed, where the sending device of the SBP termination frame may be the SBP requesting station or the SBP access point (AP). For example, in step 310, the SBP requesting station may receive the SBP termination frame with the identification bit as the first value from the SBP access point (AP). Alternatively, in step 310, the SBP access point (AP) may receive the SBP termination frame with the identification bit as the first value from the SBP requesting station.

According to the example of the disclosure, the identification bit may be set to a second value to identify that no station meeting demands of the SBP requesting station is found to be participated in the sensing measurement and a termination flow is initiated, where the sending device of the SBP termination frame is the SBP access point (AP). For example, in step 310, the SBP requesting station may receive the SBP termination frame with the identification bit as the second value from the SBP access point (AP).

According to the example of the disclosure, the SBP termination frame may further include a sensing measurement setup ID corresponding to the sensing measurement.

According to the example of the disclosure, in a case that the identification bit is set to the first value, the sensing measurement setup ID may correspond to the completed sensing measurement; and in a case that the identification bit is set to the second value, the sensing measurement setup ID may be withdrawn.

According to the example of the disclosure, in a case that the identification bit is set to the second value, the SBP termination frame may further include a time information bit and a sensing measurement setup ID, where the time information bit may be configured to identify time at which the SBP requesting station sends an SBP requesting frame for the sensing measurement again, and the sensing measurement setup ID may be an existing sensing measurement setup ID of the sensing measurement.

According to the example of the disclosure, the SBP termination frame may further include a type identification bit for identifying a frame type as the SBP termination frame.

In step 320, corresponding operations may be performed based on the SBP termination frame.

In an example of the disclosure, the communication method shown in FIG. 3 may be performed by the SBP access point (namely, SBP AP). For example, in response to determining that in step 310, the SBP termination frame with the identification bit as the first value is received from the SBP requesting station by the SBP access point (AP), and the SBP access point (AP) may end the corresponding sensing measurement in step 320.

In another example of the disclosure, the communication method shown in FIG. 3 may be performed by the SBP requesting station (namely, SBP requesting STA).

For example, in response to determining that in step 310, the SBP termination frame with the identification bit as the first value is received from the SBP access point (AP) by the SBP requesting station, the SBP requesting station may end the corresponding sensing measurement in step 320.

For example, in response to determining that in step 310, the SBP termination frame with the identification bit as the second value is received from the SBP access point (AP) by the SBP requesting station, the SBP requesting station may terminate the corresponding sensing measurement in step 320. Alternatively further, the corresponding sensing measurement setup ID is deleted (or withdrawn). Alternatively, the SBP requesting station may send the SBP requesting frame again within the specific time of the SBP AP according to the time information bit carried in the SBP termination frame in step 320, and in this case, the existing sensing measurement setup ID may be used.

According to the communication method of the example of the disclosure, the SBP termination flow is perfected, and behaviors of the SBP requesting STA are explicitly stipulated, such that resources are better used.

FIG. 4 illustrates a block diagram of a communication apparatus according to an example. The communication apparatus 400 in FIG. 4 may include a processing module 410 and a transceiving module 420. In an example of the disclosure, the communication apparatus 400 shown in FIG. 4 may be applied to a sending device; and in another example of the disclosure, the communication apparatus 400 shown in FIG. 4 may be applied to a receiving device. The sending device may be an SBP requesting station or an SBP access point (AP). In a case that the sending device is the SBP requesting station, the receiving device may be the SBP access point (AP); and in a case that the sending device is the SBP access point (AP), the receiving device may be the SBP requesting station.

In a case that the communication apparatus 400 shown in FIG. 4 may be applied to the sending device, the processing module 410 may be configured to: determine an SBP termination frame, where the SBP termination frame may include an identification bit for identifying a completion status of sensing measurement; and the transceiving module 420 may be configured to: send the SBP termination frame. That is to say, the communication apparatus 400 shown in FIG. 4 may perform the communication method described with reference to FIG. 2 and various transformed examples, and for avoiding redundancy, repeated descriptions are omitted here.

In a case that the communication apparatus 400 shown in FIG. 4 may be applied to the receiving device, the transceiving module 420 may be configured to: receive the SBP termination frame, where the SBP termination frame may include an identification bit for identifying a completion status of sensing measurement; and the processing module 410 may be configured to:

control performing corresponding operations based on the SBP termination frame. That is to say, the communication apparatus 400 shown in FIG. 4 may perform the communication method described with reference to FIG. 3 and various transformed examples, and for avoiding redundancy, repeated descriptions are omitted here.

It will be understood that the communication apparatus 400 shown in FIG. 4 is example, the example of the disclosure is not limited to this, for example, the communication apparatus 400 may further include other modules, for example, a memory module. In addition, the modules in the communication apparatus 400 may be combined into a more complicated module, or may be divided into more separate modules.

According to the communication method and the communication apparatus of the examples of the disclosure, the SBP termination flow is perfected, behaviors of the SBP requesting STA are explicitly stipulated, such that resources are better used.

Based on the principle similar to the communication method provided by the example of the disclosure, an example of the disclosure further provides an electronic apparatus, and the electronic apparatus includes a processor and a memory. A machine readable instruction (may also be called “computer program”) is stored in the memory; and the processor is used to execute the machine readable instruction to implement the communication method described with reference to FIG. 2 and FIG. 3.

An example of the disclosure further provides a non-transitory computer readable storage medium, a computer program is stored on the non-transitory computer readable storage medium, and the computer program, when executed by a processor, implements the communication method described with reference to FIG. 2 and FIG. 3.

In an example, the processor may be various example logic blocks, modules and circuits described in conjunction with contents of the disclosure for implementing or executing, for example, it may be a central processing unit (CPU), a general-purpose processor, a digital signal processor (DSP), an application specific integrated circuit (ASIC), a field programmable gate array (FPGA), or other programmable logic devices, transistor logic devices, hardware components or any combination. The processor may also be a combination implementing a computing function, for example, it may be a combination of one or more microprocessors, a combination of a DSP and a microprocessor, etc.

In an example, the memory may be, for example, a read only memory (ROM), a random access memory (RAM), an electrically erasable programmable read only memory (EEPROM), a compact disc read only memory (CD-ROM), or other optical disc memories, optical disk memories (including a compact optical disk, a laser disk, an optical disk, a digital general optical disk, a blue-ray disk, etc.), a magnetic disk storage medium or other magnetic storage devices, or any other media capable of being configured carry or store program codes with instruction or data structure forms and capable of being stored and taken by a computer, but it is not limited to this.

It is to be understood that although steps of the flow charts of the accompanying drawings are sequentially displayed according to the indication of arrows, these steps are not inevitably sequentially executed according to an order indicated by the arrows. Unless expressly stated here, these steps are executed without a strict order limitation, and may be executed in other orders. In addition, at least a part of steps in the flow chats of the accompanying drawings may include a plurality of sub-steps or a plurality of stages, these sub-steps or stages are not inevitably completed at the same moment, may be executed at different moments, execution orders are not also inevitably sequentially performed, and may be in turn or alternated with other steps or sub-steps of other steps or at least a part of the stages.

Although the disclosure has been shown and described by referring to some examples of the disclosure, those skilled in the art will understand that various changes may be performed on forms and details without departing from the scope of the disclosure. The scope of the disclosure is not limited to the examples, but limited by appended claims and equivalents of the claims.

1. A communication method for sensing by proxy (SBP), comprising:
determining an SBP termination frame, wherein the SBP termination frame comprises an identification bit for identifying a completion status of sensing measurement; and
sending the SBP termination frame.

2. The communication method according to claim 1, wherein the identification bit is set to a first value to identify that the sensing measurement has been completed, wherein
a device for sending the SBP termination frame is an SBP requesting station or an SBP access point (AP).

3. The communication method according to claim 1, wherein the identification bit is set to a second value to identify that no station meeting demands of an SBP requesting station is found to be participated in the sensing measurement and a termination flow is initiated, wherein
a device for sending the SBP termination frame is an SBP access point (AP).

4. The communication method according to claim 2, wherein the SBP termination frame further comprises a sensing measurement setup ID corresponding to the sensing measurement.

5. The communication method according to claim 4, wherein
in response to determining that the identification bit is set to a first value, the sensing measurement setup ID corresponds to the completed sensing measurement; and
in response to determining that the identification bit is set to a second value, the sensing measurement setup ID is withdrawn.

6. The communication method according to claim 3, wherein the SBP termination frame further comprises a time information bit and a sensing measurement setup ID, wherein the time information bit is configured to identify time at which the SBP requesting station sends an SBP requesting frame for the sensing measurement again, and the sensing measurement setup ID is an existing sensing measurement setup ID of the sensing measurement.

7. The communication method according to claim 1, wherein the SBP termination frame further comprises a type identification bit for identifying a frame type as the SBP termination frame.

8. A communication method for sensing by proxy (SBP), comprising:
receiving an SBP termination frame, wherein the SBP termination frame comprises an identification bit for identifying a completion status of sensing measurement; and
performing corresponding operations based on the SBP termination frame.

9. The communication method according to claim 8, wherein the identification bit is set to a first value to identify that the sensing measurement has been completed, wherein
a sending device of the SBP termination frame is an SBP requesting station or an SBP access point (AP).

10. The communication method according to claim 8, wherein the identification bit is set to a second value to identify that no station meeting demands of an SBP requesting station is found to be participated in the sensing measurement and a termination flow is initiated, wherein
a sending device of the SBP termination frame is an SBP access point (AP).

11. The communication method according to claim 9, wherein the SBP termination frame further comprises a sensing measurement setup ID corresponding to the sensing measurement.

12. The communication method according to claim 11, wherein
in response to determining that the identification bit is set to a first value, the sensing measurement setup ID corresponds to the completed sensing measurement; and
in response to determining that the identification bit is set to a second value, the sensing measurement setup ID is withdrawn.

13. The communication method according to claim 10, wherein the SBP termination frame further comprises a time information bit and a sensing measurement setup ID, wherein
the time information bit is configured to identify time at which the SBP requesting station sends an SBP requesting frame for the sensing measurement again, and the sensing measurement setup ID is an existing sensing measurement setup ID of the sensing measurement.

14. The communication method according to claim 8, wherein the SBP termination frame further comprises a type identification bit for identifying a frame type as the SBP termination frame.

15. (canceled)

16. (canceled)

17. An electronic apparatus, comprising a memory, a processor and a computer program stored on the memory and capable of running on the processor, wherein the processor implements the following steps when executing the computer program:
determining an SBP termination frame, wherein the SBP termination frame comprises an identification bit for identifying a completion status of sensing measurement; and
sending the SBP termination frame.

18. A non-transitory computer readable storage medium, wherein a computer program is stored on the non-transitory computer readable storage medium, and the computer program, when executed by a processor, implements the communication method according to claim 1.

19. The electronic apparatus according to claim 17, wherein the identification bit is set to a first value to identify that the sensing measurement has been completed, wherein a device for sending the SBP termination frame is an SBP requesting station or an SBP access point (AP).

20. The electronic apparatus according to claim 17, wherein the identification bit is set to a second value to identify that no station meeting demands of an SBP requesting station is found to be participated in the sensing measurement and a termination flow is initiated, wherein
a device for sending the SBP termination frame is an SBP access point (AP).

21. An electronic apparatus, comprising a memory, a processor and a computer program stored on the memory and capable of running on the processor, wherein the processor, when executing the computer program, implements the communication method according to claim 8.

22. A non-transitory computer readable storage medium, wherein a computer program is stored on the non-transitory computer readable storage medium, and the computer program, when executed by a processor, implements the communication method according to claim 8.
